(19) United States
(12) Patent Application Publication
(10) Pub. No.: US 2017/0282785 A1
(43) Pub. Date: Oct. 5, 2017

(54) REAR LIGHTING AND/OR SIGNALING DEVICE FOR A MOTOR VEHICLE, AND REAR LIGHTING AND/OR SIGNALING LIGHT PROVIDED WITH SUCH A DEVICE

(71) Applicant: VALEO VISION, Bobigny Cedex (FR)

(72) Inventors: Pierre Albou, Bobigny Cedex (FR); Xavier Morel, Bobigny Cedex (FR)

(73) Assignee: VALEO VISION, Bobigny Cedex (FR)

(21) Appl. No.: 15/474,429

(22) Filed: Mar. 30, 2017

(30) Foreign Application Priority Data
Mar. 30, 2016 (FR) 16 52742

(51) Int. Cl. B60Q 1/26; F21S 8/10; B60Q 1/50; B60Q 1/38; B60Q 1/44; F21V 8/00; B60Q 1/30

(52) U.S. Cl. CPC B60Q 1/2607; G02B 6/0006; G02B 6/0008; F21S 48/2237; F21S 48/23; F21S 48/21; B60Q 1/30; B60Q 1/38; B60Q 1/44; F21S 48/215; B60Q 1/503; F21Y 2115/10

(57) ABSTRACT

The present invention relates to a rear lighting and/or signaling device, notably for a motor vehicle, comprising a light source, a transmission surface and means for distributing at least a part of the light from the source on the transmission surface, the distribution means comprising a matrix of micromirrors that can each be driven according to at least two different inclination positions. Another source is present and a mode of operation allows the illumination of a part of the micromirrors by the source and another part by the source.

The present invention relates in particular to a rear lighting and/or signaling device for a motor vehicle, and to a rear lighting and/or signaling light provided with such a device.

A preferred application relates to the motor vehicle industry, for equipping vehicles, in particular for producing devices capable of being able to emit light beams, also called lighting and/or signaling functions, that, in general, meet vehicle rear regulations. For example, the invention can allow the production of a highly resolved light beam of pixelated type, notably for signaling at the rear of a vehicle. It can be used, non-exclusively, to display pictograms on a projection surface embedded in the vehicle.

The signaling lights of a motor vehicle situated at the rear of the vehicle are light devices which comprise one or more light sources and an outer lens which encloses the light. To put it simply, the light source emits light rays to form a light beam which is directed toward the outer lens in order to produce an illuminating band which transmits light out of the vehicle. The color of the illuminating band is characteristic of the function or type of light. Thus, it is known that a lighting band of white color indicates that the light is a reversing light, that a lighting band of amber color is a direction indicator, and that a lighting band of red color is a rear position light or a stop light, the stop light having a more intense brightness. There are also red fog lights, the intensity of which is even stronger to be visible in difficult weather conditions, such as fog, heavy rain or falling snow. In addition to the color, these lights have to meet the regulations concerning light intensity and visibility angles in particular.

However, although each rear light has a regulated particular meaning, that can prove insufficiently detailed or accurate for an observer. It is necessary to decode the color and the type of light which is actuated to try to understand the intention of the driver of a vehicle or, for example, the emergency situation that he or she is encountering. Thus, when the vehicles are in traffic, it is not obvious or possible to understand precisely the situation encountered by a vehicle when one of its lights comes on. In effect, even if the driver of a following vehicle observes the switching-on of a stop light on a vehicle ahead of him or her, the simple switching-on of the light does not give him or her any indication as to the exact cause of the braking.

In addition, since the number of different rear lights is limited to those described previously, some situations are difficult to describe with such a restricted number of messages. In many situations, a vehicle cannot accurately warn the other vehicles of the events which are occurring.

Vehicle rear lighting systems are known that comprise a matrix of micromirrors arranged between a light source and a screen. An assembly of input lenses is inserted between the source and the matrix and an assembly of output lenses is inserted between the matrix and the screen. This assembly allows the projection of light whose distribution can be modified by driving each micromirror. It is thus possible to increase the information supplied as output from the duly equipped light, by producing, for example, different display light forms on the screen. However, the assembly thus proposed is complex in light of its use, which is essentially limited to forming a pattern of a unique beam to be projected onto the screen.

There is a need for rear lighting and/or signaling devices which are of less limited use than the existing ones.

The present invention aims to at least partly meet this objective.

To this end, the present invention relates notably to a rear lighting and/or signaling device, notably for a motor vehicle, comprising a light source, a transmission surface and means for distributing at least a part of the light from the source on the transmission surface, the distribution means comprising a matrix of micromirrors that can each be driven according to at least two different inclination positions comprising a first position in which rays from the source are returned by a micromirror to the transmission surface and a second position in which the rays from the source are not returned by a micromirror to the transmission surface. Advantageously, it comprises at least one additional light source configured such that rays from the additional source are returned by a micromirror to the transmission surface when said micromirror is in the second position and are not returned by a micromirror to the transmission surface when said micromirror is in the first position.

Preferably, and in a nonlimiting manner, the distribution means comprise at least one hybrid mode of operation in which the source and the additional source are simultaneously emissive and in which at least a part of the micromirrors are in the first position and at least another part of the micromirrors are in the second position.

There is thus a device that is much more comprehensive than the current techniques in as much as the matrix of micromirrors is employed for a plurality of the beams each emitted from a different source, and not dedicated solely to a single source. Furthermore, the matrix is used in both positions of the mirrors whereas one of the positions was inactive in the prior art.

With an advantageous hybrid mode of operation, the light leaving the matrix originates simultaneously from at least two sources, which allows for more numerous functionalities. For example, the red rear light can be active at the same time as a flashing direction change light all employing the matrix of micromirrors as element for distributing beams to be transmitted via the transmission surface.

According to a preferred aspect of the invention, the source and the additional source have different light emission wavelength intervals. It is thus possible to produce a variety of output functions. The source may be configured to emit light in the red color wavelengths. Moreover, the additional source can be configured to emit light in the orange color wavelengths.

According to an alternative aspect of the invention, the source and/or the additional source is controlled to emit light in different colors wavelengths.

According to a first alternative, the light source is an RGB electroluminescent diode, for the acronym Red, Green, Blue and includes three light emitting surfaces which emit light respectively in the red, green and blue color wavelength. The color emitted by the light source is obtained by mixing the colors emitted by the three emitting surfaces.

According to an other alternative, the light source is an electroluminescent diode with at least two emitting surfaces emitting light in different colors wavelength choose between red, orange and white. The color emitted by the light source is obtained by selectively activating the emitting surface corresponding to the wanted color.

The radiated power of at least one out of the source and the additional source is advantageously less than 1 W. This is in accordance with the powers usually sufficient for the rear lighting and/or signaling functions. The heating caused by such powers is also limited, which greatly simplifies the design of the devices.

In one embodiment, the source and the additional source share a same primary source, the device comprising a splitter of light rays from the primary source between the source and the additional source. In this case, the source and the additional source are secondary sources. That simplifies the light generation design, because a single primary source can be employed. In case of failure, only one source has to be replaced and the primary source is less bulky than the proliferation of complete primary sources involving the proliferation of mechanical supports, of electrical power supplies for example. It can be a primary source of white color, conversion means being able, moreover, to be used to obtain colors different to white as output. An optical fiber may conduct the light from the primary source to the splitter. In addition or alternatively, at least one out of the source and the additional source can comprise an optical fiber conducting light output from the splitter (34) and a distal end of which is directed toward the matrix. There is thus a path for passage of the light toward the matrix. This arrangement is less bulky.

Advantageously, at least one out of the source and the additional source comprises a conversion device configured to receive light from the primary source and to re-emit light converted to a wavelength interval different from that of the light from the primary source. The change of color described above is thus obtained.

The conversion device can comprise luminophor elements.

According to another possible embodiment of the invention, a light diffuser is configured to receive light rays from the primary source and to return them at least partly to the transmission surface, without reflection on the matrix. It can be a light diffuser picking up a part of the rays from the optical fibers placed on the path of the rays from the primary source and toward the matrix of micromirrors. This way, it is notably possible to create a style lighting and/or participate photometrically in a regulatory function, possibly permanent, on the rear light.

The distribution means optionally comprise at least one other mode of operation in which the source is emissive and the additional source is non-emissive and in which at least a part of the micromirrors are in the first position and at least another part of the micromirrors are in the second position. A single beam is then projected onto the transmission surface, to produce a single function from the source.

According to an alternative or additional possibility, the distribution means comprise at least one other mode of operation in which the source is non-emissive and the additional source is emissive and in which at least a part of the micromirrors are in the first position and at least another part of the micromirrors are in the second position. A single beam is then projected onto the transmission surface, to produce a single function from the additional source.

Another possibility is that the distribution means comprise at least one other hybrid mode of operation in which the source and the additional source are simultaneously emissive and in which at least a part of the micromirrors are in the first position and at least another part of the micromirrors are in the second position, the number of micromirrors in the first position and/or in the second position being different therein from the number of micromirrors in the first position and/or in the second position of the hybrid mode of operation. It is thus possible to vary the form and/or the intensity of the beams produced impacting on the transmission surface.

At least one out of the source and the additional source is advantageously configured to emit a light beam passing as source output through a surface whose larger dimension is less than 100 μm. The term radius possibly employed here does not imply that the beam is of circular section at this point and this term is employed to signify an assessment of the size of the beam. Generally, it is advantageous for the source to be a quasi-spot source so as to directly impact the matrix of micromirrors, notably with no intermediate optic. In this context, the light beam is possibly divergent and/or directly illuminates the matrix of micromirrors.

At least one out of the source and the additional source can comprise at least one out of: a light-emitting diode, a laser emitter, a semiconductor light source comprising a plurality of light-emitting units of submillimetric dimensions, the units being distributed in different, selectively activatable light zones. In particular, each of the light-emitting light units of submillimetric dimensions takes the form of a stick. Furthermore, the sticks are on one and the same substrate, which preferably comprises silicon.

Another aspect of the invention relates to a rear lighting and/or signaling light of a motor vehicle equipped with at least one lighting and/or signaling device according to the invention. Preferably, another aspect of the invention relates to a rear signaling light of a motor vehicle equipped with at least one rear signaling device.

This light can comprise an outer lens for outputting light and for enclosing the light, said outer lens comprising the transmission surface.

According to additional possibilities of embodiment of at least one of the light sources of the invention, possibilities which can be employed alone or according to all combinations, the device is such that:
the source and/or the additional source is configured to emit a light beam whose source output radius is less than a value Rs solving the following equation:

$${T}_{P} = 2 D \{ tg ( atan \frac{x}{y} - 2 α - \frac{π}{2} ) - tg ( atan \frac{x}{y} - 2 α - atan \frac{{R}_{S}}{\sqrt{{x}^{2 +} {y}^{2}}} - \frac{π}{2} ) \}$$

in which
x (which is the distance between the middle of the output surface of the source considered and the plane containing the axes of rotation of the micromirrors) is the solution of the following equation:

$$\frac{1 - L}{D} = \frac{1}{tg ( π - atan ( \frac{x}{y - \frac{L}{2}} ) - 2 α )} \frac{1}{tg ( π - atan ( \frac{x}{y + \frac{L}{2}} ) - 2 α )}$$

with:
I is the width of the image produced on the transmission surface;
L is the lengthwise or widthwise dimension (preferably the greater of the two) of the matrix of micromirrors;
D is the distance separating the transmission surface and the matrix of micromirrors;
α is the maximum angle of tilt of a micromirror relative to the plane containing the axes of rotation of the micromirrors.

### Also:

y corresponds to the distance between the middle of the central micromirror and the orthogonal projection of the middle of the output of the source on a plane parallel to the transmission surface.
The central micromirror is the micromirror of the matrix of micromirrors which is situated closest to the geometrical center of the matrix of micromirrors;
According to a particularly advantageous embodiment, the radius Rₛ is less than 100 μm. According to this aspect, which may be dissociated from the other aspects of the invention, the diameter is chosen to be very small such that the source can be likened to a quasi-spot source.
Also advantageously, the light beam is divergent. In particular, a conical beam form makes it possible to not lose too much light around the matrix of micromirrors, which is usually of rectangular outline.
Advantageously, the light beam directly illuminates the matrix of micromirrors. According to this aspect, which may be dissociated from the other aspects of the invention, recourse to an input optic is then avoided.
Preferentially, the diameter of the beam impacting the matrix of micromirrors is equal to the greatest dimension of the matrix of micromirrors. This way, and preferably with no intermediate element, the source produces an illumination of optimal efficiency of the matrix with a beam size, at the point of the matrix, just sufficient to illuminate all the mirrors. For example, the diameter of the beam can equal (which covers dimension deviations for example of +1-10%) or be slightly greater than the diagonal of the matrix also called DMD (for Digital Micromirror Device) which is preferably rectangular. More specifically, the intersection of a conical beam with the plane of the DMD can be elliptical. Ideally, this ellipse passes through the four corners of the DMD. In practice, because of the asymmetry of the system, it passes through two corners of the DMD and covers all of its surface.
Optionally, the distribution means consist of the matrix of micromirrors. According to this aspect, which may be dissociated from the other aspects of the invention, no other element is in fact absolutely essential between the source and the transmission surface.
Advantageously, the matrix of micromirrors is configured to produce an output beam projected directly onto the transmission surface. According to this aspect, which may be dissociated from the other aspects of the invention, recourse to intermediate transformation elements, such as one or more lenses, whose presence would pose problems of image blurring or, at the very least, a choice of specific optic to be added.
Preferentially, the source is situated offset relative to the mean direction of the output beam, so as not to interfere with said output beam.
Advantageously, the source comprises at least one out of: a light-emitting diode, a laser emitter, a light-emitting stick microsource.
Preferably, the source comprises a device for generating an input light beam and a transformation element configured to reduce the radius of the input light beam.
Advantageously, the transformation element comprises at least one out of: a diaphragm, a lens, a reflector, an optical fiber.
Optionally, the plane of the matrix of micromirrors forms an angle with a normal to the transmission surface with a non-zero value strictly less than 45°, preferably less than 30°.
Preferentially, said angle is zero.

Thus, according to these aspects of the invention, the source considered can be sufficiently close to an ideal spot source for correctly illuminating the matrix of micromirrors in conditions which avoid the systematic recourse to optical elements and in particular to a lens between the matrix and the transmission surface. In addition to a certain simplification, the elimination of this lens avoids the phenomena of blurring at the edges of the screen observed hitherto because of the difference in distance to the lens from the mirrors of the matrix which is inclined relative to the normal to the transmission surface. Even without inclination, if the centers of the image and of the DMD are not aligned along the normal to both surfaces, that means a greater aperture for an aplanatic optic and therefore a greater difficulty in being sharp over the entire surface of the image.

Structurally, the source and/or the additional source can be offset to the side of the matrix relative to the transmission surface so as not to form an obstacle to the output of light rays from the matrix while concentrating the light from the source on the matrix to lose the least possible light. By virtue of the invention, the source can be distanced laterally while having an illumination targeted on the matrix of micromirrors.

Other features and advantages of the present invention will be better understood from the exemplary description and from the drawings in which:

FIG. 1 shows an existing configuration of a lighting device with a matrix of micromirrors;

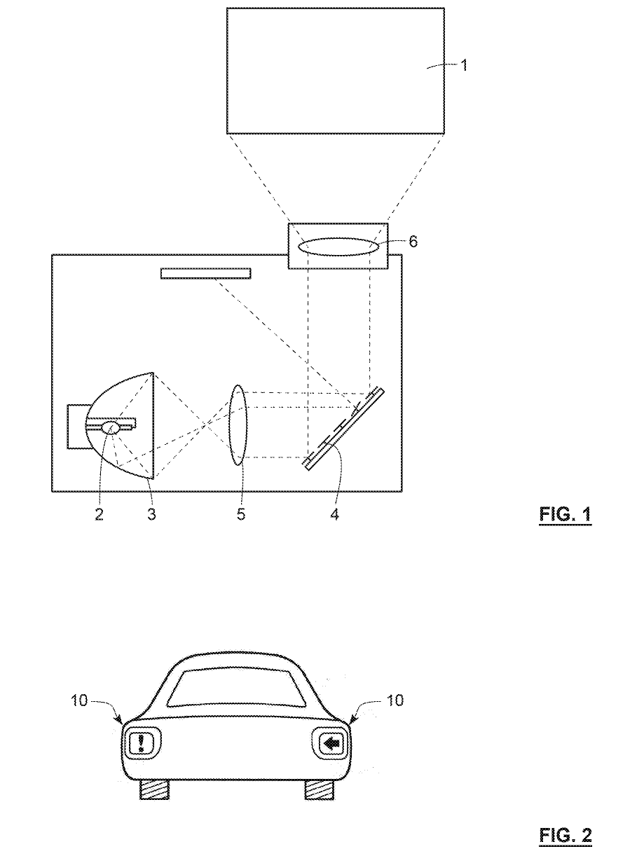

FIG. 2 schematically represents a vehicle provided with two signaling devices with pictogram display according to an embodiment of the invention;

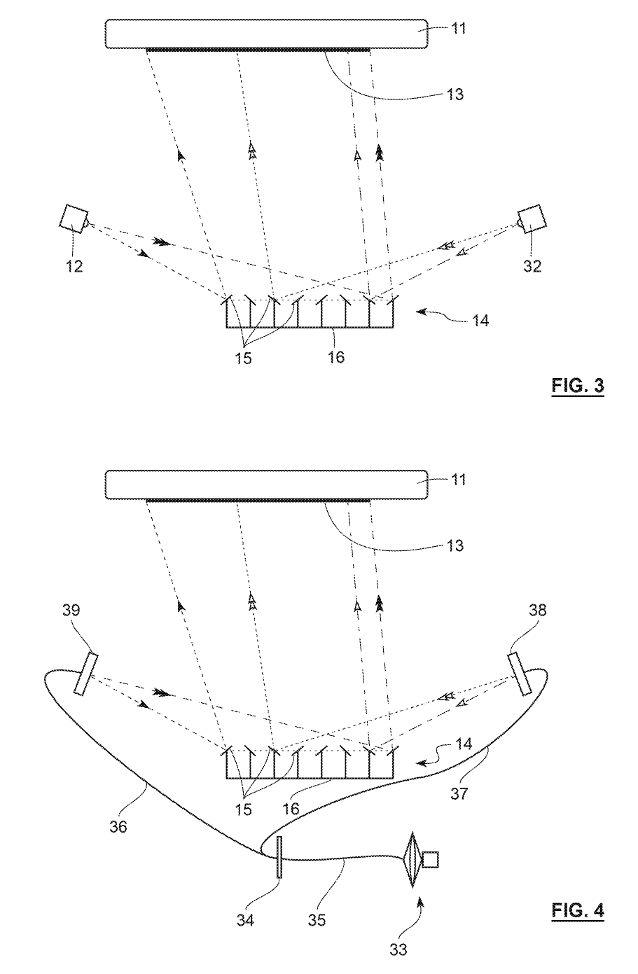

FIG. 3 illustrates, generally, components of the invention, in an embodiment;

FIG. 4 shows another embodiment of the invention;

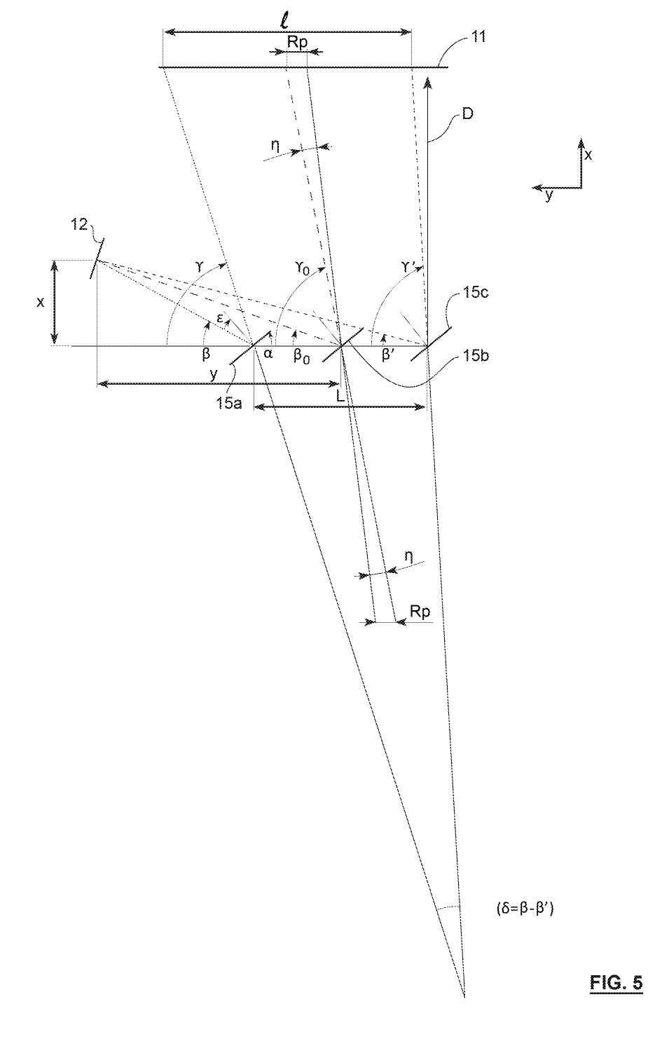

FIG. 5 illustrates a nonlimiting method for determining a diameter of at least one source;

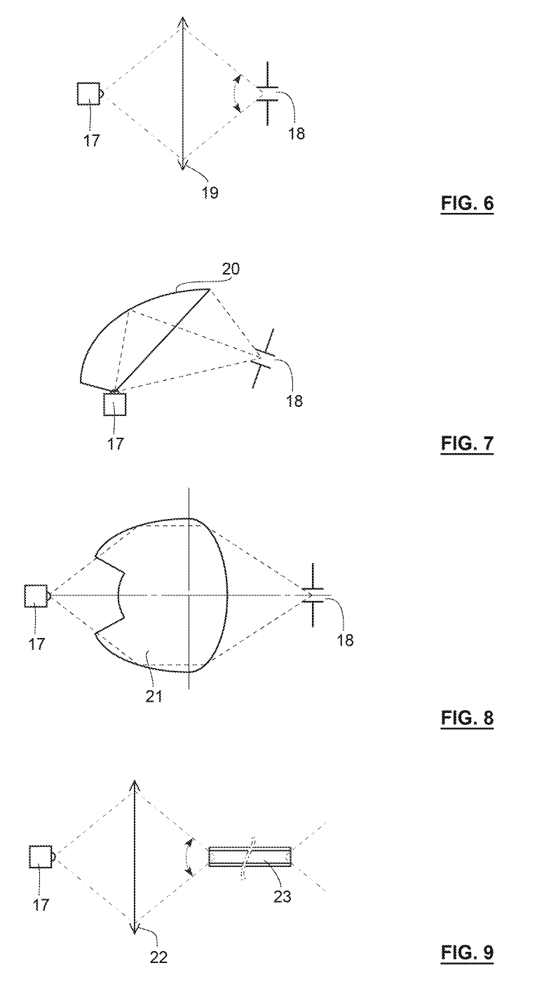

FIGS. 6 to 9 show possibilities for producing a source of small dimensions;

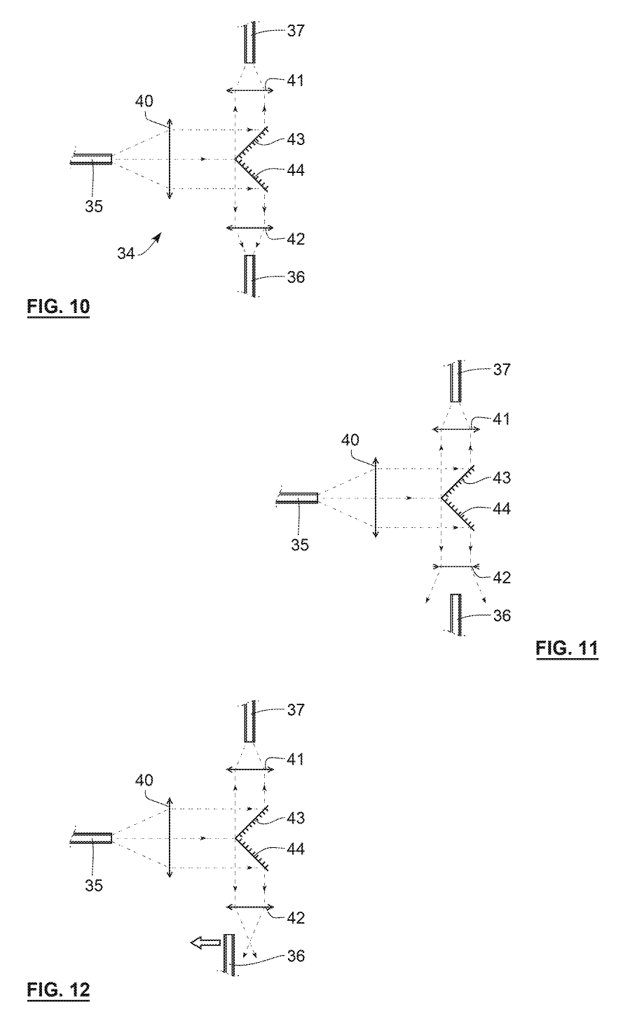

FIGS. 10 to 12 give examples of an embodiment of the invention.

Unless specifically indicated to the contrary, technical features described in detail for a given embodiment can be combined with technical features described in the context of other embodiments described in an exemplary and nonlimiting manner.

FIG. 1 represents an example of beam projection structure according to a prior art, with at least one light source 2 formed by at least one light-emitting diode and a bulky reflector 3, a transmissive surface defining the projection zone 1, and a matrix of micromirrors 4 configured to reflect the light rays from the light source to the transmission surface.

The light beam which is from the light source 2 is intended to illuminate the projection surface 1. Also provided are collimation means formed by an optical lens 5, in order to collimate the rays from the light source 2 on the matrix of micromirrors 4 and an optical system 6 for focusing the rays reflected by the matrix of micromirrors 4 toward the projection surface 1, in order for the emitted beam forming the pictogram to be well focused on the surface, for the pictogram to appear well defined and sharp.

FIG. 2 represents a rear view of a vehicle provided with two signaling devices 10 employed here to display pictograms. Each signaling device 10 comprises a transmission surface 11 arranged at the rear of the vehicle, substantially at the point where a rear signaling light is usually arranged. The function of the transmission surface 11 is, notably, to display pictograms. The pictogram is formed on the transmission surface 11. It then appears as well defined and very sharp.

The regulatory photometric characteristics of the rear signaling lights such as the position lights, direction indicator, stop light or fog light are well defined. They relate notably to the minimum and maximum light intensity ranges to be observed, the visibility angle of the beam, the color of the beam, the surface area of the light surface of the function, or even the minimum distance between different functions. For example, a fog light must be at least 10 cm from the stop light to avoid them being confused.

The display is advantageously configured for at least one emitted light beam to alone fulfil the regulatory photometric characteristics of a defined signaling function. In an embodiment with pictogram display, each pictogram displayed is parameterized to emit a light beam which meets all the abovementioned regulatory requirements. A single pictogram can notably fulfill several functions simultaneously or alternately, such as, for example, a flashing light and a position light. Several pictograms can also be displayed simultaneously or alternately, each pictogram filling the photometric characteristics of a different function of the signaling light.

Preferably and advantageously, the rear signaling function produced with the pictogram or pictograms is at least one function out of the following: position light (or side marker light) or a combined side marker light and stop light function.

FIG. 3 shows an exemplary embodiment of the invention. A source 12 is schematically represented in the lefthand part of the figure and constitutes the part generating the light which will be transformed in the rest of the device. The latter also comprises light distribution means making it possible to produce several light output configurations. These means comprise or are formed by a matrix 14 of micromirrors. The mirrors 15 allow, according to their state of activation, the reflection of light toward the transmission surface 11. The latter transmission surface 11 is the downstream element of the device. It is a zone through which light reflected by the matrix 14 is brought to the outside.

According to the invention, another source, called additional source 32, is provided to illuminate the matrix 14. In the illustration of FIG. 3, a source 32, separate from the source 12, is arranged on one side of the matrix 14 opposite that where the source 12 is present. In particular, it is possible to define a median plane of the matrix, passing through the middle of one of its length or width dimensions and at right angles to the support of the matrix (the plane cutting the matrix in the direction of its thickness), the sources 12 and 32 being situated on either side of this median plane. The placement of the sources 12, 32 may be symmetrical about this plane.

The sources 12, 32 may be of different colors, for example one red, the other orange. Or else, one source may be white and the other red or orange. It is also possible to provide more than two sources, for example a white source, a red source and an orange source. Provision can be made for two of these three sources to be placed so as to illuminate the matrix 14 for the light to be returned toward the transmission surface when the mirrors are in a same position, and for said two sources to be emissive alternately. The additional source is therefore for example split into two and two sources are present on this side of the matrix 14. It is also possible to provide two sources only, but with a variation of color of one of them, at least so as, for example, to switch from orange to red and vice versa depending on the functions to be fulfilled. This variation can be worked by a switch directing, on command, the rays (for example of white color initially) to one or other of the two color conversion devices differing by the color re-emitted. Examples of conversion devices are given below.

In the case of FIG. 3, the sources 12, 32 are totally distinct sources in as much as the light that they project onto the matrix is not from a same original source.

Generally, the present invention can use light sources which can comprise or integrally consist of light emitters of the light-emitting diode type, also commonly called LEDs. In particular, these LEDs can be provided with at least one chip capable of emitting a light of intensity that can advantageously be adjusted according to the lighting and/or signaling function to be produced. Moreover, the term light source or light emitter is understood here to cover a set of at least one elementary source such as an LED capable of producing a flux causing at least one light beam to be generated as output from the device of the invention. The light source is for example formed by at least one light-emitting diode. Advantageously, it is a set of light sources, a set of the multi-chip light-emitting diode type, that is to say a single electronic component comprising a plurality of light-emitting emitters.

According to one feature, the light emitted by these light-emitting diodes is red, amber or white. Other types of sources can also be envisaged in the invention, such as one or more laser sources, for example laser diodes. In this latter case, it is advantageous for this type of emitter to be associated with an element conferring less coherence on the light outgoing from this assembly forming the source, such as a re-emissive, for example luminophor such as phosphorescent layer.

According to one possibility, the source 12, for example red, is of laser type, preferably coupled to a re-emissive device according to the paragraph above, and the source 32, for example orange, is of LED type.

Light of red color is preferably understood to mean light whose wavelengths are within a range of wavelengths of the spectrum visible to the human eye and above 600 nm, preferably between 620 nm and 750 nm.

Light of orange color is preferably understood to mean light whose wavelengths are within a range of wavelengths of the spectrum visible to the human eye between 584 nm and 605 nm. Reference can also, or alternatively, be made to the AFNOR X08-010 standards for the definition of the colors.

One or more of the light sources envisaged here can also be monochromatic. Thus, the terms such as wavelength interval are understood to cover intervals consisting of a single wavelength value.

According to an advantageous aspect of the invention, the source 12 is configured to emit a beam, toward the distribution means, typically a matrix 14 of micromirrors, so as to cover all the mirrors, without in any way generating, at the source 12 output, a significant beam size. Preferably, this beam has a tapered and divergent envelope. The invention makes it possible to avoid recourse to optical elements, operating as beam collimator (such as a suitable lens), and the beam can directly impact the matrix 14 of micromirrors, which does not exclude recourse to particular elements (optical in particular) to form the source itself.

Examples of dimensionings of the source 12 and of physical embodiments of sources of reduced size, preferably comparable to primary or secondary spot sources, are given later in the description. These subsequent examples and the comments above are also valid for the at least one additional source 32.

In the embodiment of FIG. 3, the light distribution means comprise a matrix of micromirrors 14 (also known by the acronym DMD, for “Digital Micromirror Device”) which directs the light rays by reflection. The light rays from one of the sources 12, 32 are reflected in two possible directions: either toward the transmission surface 11, or in a different direction.

To this end, each micromirror can pivot between two fixed positions about an axis, a first position in which the light rays from a given source 12, 32 are reflected toward the transmission surface, and a second position in which the light rays are reflected in a different direction from the optical focusing system. The two fixed positions are preferably oriented in the same way for all the micromirrors and form, relative to a reference support plane of the matrix of micromirrors, an angle characteristic of the matrix 14 of micromirrors, defined in its specifications. This angle is generally less than 20° and for example has a value of approximately 12°.

In the case represented, the reference plane of the matrix 14 of micromirrors is parallel to a plane of a zone of the transmission surface 11 where the beam is projected. FIG. 3 illustrates this option. In median position, a micromirror is parallel to the reference plane 16, and thus at right angles to an axis normal to the transmission surface 11. According to a variant, the reference plane 16 of the matrix 14 is not parallel to the transmission surface 11 but slightly inclined, for example by less than 20′.

Preferably, the source 12 is situated laterally offset relative to a space separating the matrix 14 of micromirrors and the transmission surface 11, and is at a shorter distance than the matrix 14 in a direction normal to the transmission surface 11. In particular, according to this preferred aspect, the invention reduces, even cancels, this inclination which favors the sharpness of the output image, over its entire surface, including at its edges.

Generally, with each micromirror reflecting a small part of the light rays from the source 12 and incident on the matrix 14, the actuation of the change of position makes it possible to modify the form of the beam emitted by the focusing system and, ultimately, on the transmission surface 11. In the case of pictogram display, the light rays returned by the micromirrors participate in the pictogram displayed by the display means. And also, the light rays from the source 12 and returned by the micromirrors in a different direction do not participate in the pictogram.

Such a system is, for example, a matrix of micromirrors 14 of rectangular outline with micromirrors with sides measuring 10 μm. It will be noted that this dimension is very small and can be disregarded, which is the way of the calculation given hereinbelow. Generally, the value Rp below is an increasing function of the size of the mirrors. Each micromirror preferentially has two operating positions. A position called first position corresponds to an orientation of the micromirrors allowing the reflection to an output diopter (such as the transmission surface 11) of an incident light beam from the source 12. A position called second position corresponds to an orientation of the micromirrors allowing the reflection to an absorbent surface of an incident light beam from the source 12, that is to say toward a different output direction. In practice, each mirror can be in permanent motion, oscillating between the two positions, and it is the ratio of time mostly spent in one of the positions which is likened to a fixed position in this situation.

FIG. 5 refers to a central mirror 15b which extends as a mirror of the matrix whose center is situated at the center of the matrix 14 or which is closest thereto.

According to the invention, at least one other source 32 is arranged such that these light rays impact the matrix 14. Furthermore, the arrangement of the source 32 is such that, in the first position of the mirrors, the rays from the source 32 are not directed toward the transmission surface 11. Conversely, the rays from the source 32 are directed toward the transmission surface 11 when the mirrors are in the second position. Consequently, a mirror in active position for the source 12 is in inactive position for the source 32 and vice versa. FIG. 3 represents an example of this situation with the formation of a combined projection from the two sources 12, 32 at a point 13 of the transmission surface 11.

In the case of a beam of divergent circular section and of a rectangular (or square) matrix, it will preferably be arranged for the diameter of the beam impacting the matrix to be identical to the greater diagonal of the matrix and for the beam to be centered on the point of intersection of the diagonals of the matrix.

The driving of the matrix 14 of micromirrors is advantageously performed by driving electronics. This driving comprises both the driving of the orientations of the micromirrors, but also the rate of overlap of the light sub-beams. The driving of the micromirrors therefore makes it possible to modify pixilation of the light sub-beams.

The transmission surface 11 receives the light from the micromirrors, preferably directly. This surface ensures the projection of beams according to the form parameters defined by the configuration ordered of the matrix 14 of micromirrors and/or the production of pictograms then displayed on the transmission surface 11. This surface is transmissive and is, for example, arranged on the enclosing outer lens of the light or else is formed by a translucent screen placed behind this enclosing outer lens. In particular, the transmission surface 11 is produced in a light-diffusing material which can be a diffractive diffuser (DOE—diffractive optical element) which offers the advantage of allowing the production of a customized bidirectional transmittance distribution function or BTDF, in particular with very little diffusion to the light source and a majority of the light diffused toward the outside of the device. Advantageously, the transmission surface 11 is translucent and neutral in color; the color of the pictogram displayed will then depend on the color of the light source 12. This surface 11 can, for esthetic reasons, be of the same color as the source, or even of another color desaturated or including a component of the color of the source. For simplicity, a planar surface has been represented, but this is nonlimiting.

This type of device makes it possible to have, as output, for each source 12, 32, a highly resolved light beam that is pixelated and digitized such that each pixel or pixelated ray forming this beam corresponds to a micromirror, it is then possible to activate or not activate these micro-pixels by simply driving the micromirrors. This particular feature then makes it possible to design, as required the form of the output light beam according to the requirements of the invention.

FIG. 5 presents an example of determination of the maximum dimension to be chosen for the radius of the source 12, but this example can be transposed directly to an additional source 32. Generally, the source 12 preferably has a radius less than 150 μm, advantageously less than 100 μm. The following calculation is nonlimiting. FIG. 5 is similar to FIG. 3 in its principle but is concentrated on a single source 12 in the interests of simplicity. It shows rays progressing in the device of the invention, according to given angles. The matrix of micromirrors is here seen in cross section according to the mean direction of its greatest dimension (its length, here parallel to the transmission surface 11).

The transmission surface 11 is represented in a way similar to FIG. 3 and is advantageously borne globally by a screen plane. In a way similar to FIG. 3, micromirrors are arranged on the micromirror matrix device. FIG. 5 shows only, on a row of micromirrors, in the lengthwise direction of the matrix in FIG. 3, only three characteristic micromirrors 15a, 15b, 15c. The first two are two end mirrors 15a, 15c. The paths of the rays reflected by these mirrors will determine the width “I” of the image produced on the transmission surface 11.

The third micromirror 15b illustrated is central, situated at the middle of the matrix 14.

For the first two mirrors 15a, 15c, the angle formed for the mirror concerned between a central ray emitted by the center of the source 12 and impacting the center of said mirror, and a plane parallel to the screen plane passing through the center of the mirror has been called, in FIG. 5, β and β′.

The angles γ and γ′ correspond to the angle formed between the reflected ray deriving from the central ray and the plane parallel to the screen plane. Concerning the central mirror 15b, these same angles have been identified with the same letters α, β, γ by employing the index “0”. Thus, β₀ is the angle formed between a central ray from the source and impacting the middle of the central micromirror, and a plane parallel to the transmission surface.

Through application of the principles of the reflection on the mirrors, it is notably possible to write:

$$α + β + ɛ = \frac{π}{2}$$

$$ɛ = \frac{π}{2} - α - β$$

$$\begin{matrix}γ = β + 2 ɛ \\ = β + π - 2 α - 2 β \\ = π - β - 2 α\end{matrix}$$

$${γ}^{′} = π - {β}^{′} - 2 α$$

$${γ}_{0} = π - {β}_{0} - 2 α$$

A dimension of the matrix “L”, linked to the dimension “I” of the image, has also been defined. “L” is, here, the distance between the centers of the two end mirrors. It should be noted that the micromirrors are of small dimensions, typically less than 10 μm.

As indicated above, the source is arranged to emit a beam which is, at its origin, of small size, and notably of small radius, here called Rₛ. It will be understood that this dimension, however, reduced, generates an angular offset between a ray emitted by the center of the source and reaching the mirror, and a ray emitted by the edge of the source (on its border radius at its origin) and reaching the middle of the mirror.

This offset is found by symmetry in the rays reflected by the mirror on the basis of two radii indicated above. This offset is called “η” in FIG. 5. The correlation with the value “Rₛ” is also presented therein.

It will be understood that the size of a pixel (Tₚ) produced by this micromirror is a function of n and of a value D which corresponds to the distance separating, along a normal to the transmission surface, said surface and the reference plane of the matrix of micromirrors. Tₚ is itself substantially equal to twice Rₚ which is the projection onto the transmission surface 11 of the radius dimension of the source 12.

The following expressions can then be written:

$$\frac{D}{tg γ} + L - \frac{D}{tg {γ}^{′}} = L \\ \to \frac{l - L}{D} - \frac{1}{tg γ} - \frac{1}{tg {γ}^{′}}$$

$$tg β = \frac{x}{y - L \text{/} 2}$$

$$tg {β}^{′} = \frac{x}{y + L \text{/} 2}$$

$$tg {β}_{0} = \frac{α}{y}$$

$$tg η = \frac{{R}_{S}}{\sqrt{{x}^{2} + {y}^{2}}}$$

$$Dtg ( \frac{π}{2} - {γ}_{0} ) - Dtg ( \frac{π}{2} - {γ}_{0} - η ) = {R}_{P} \\$$

For a fixed lateral deviation y, the distance x from the source to the DMD(x) is the solution of:

$$\frac{l - L}{D} = \frac{1}{tg ( π - atan ( \frac{x}{y - \frac{L}{2}} ) - 2 α )} - \frac{1}{tg ( π - atan ( \frac{x}{y + \frac{L}{2}} ) - 2 α )} \\ and \\ {T}_{P} = 2 D \{ tg ( atan \frac{x}{y} - 2 α - \frac{π}{2} ) - tg ( atan \frac{x}{y} - 2 α - atan \frac{{R}_{S}}{\sqrt{{x}^{2 +} {y}^{2}}} - \frac{π}{2} ) \} \qquad$$

### With:

I is the width of the image produced on the transmission surface 11;
L is the length or width dimension (preferably the greater of the two) of the matrix of micromirrors;
D is the distance separating the transmission surface 11 and the matrix of micromirrors 14; this distance is preferably taken along a normal to the transmission surface 11 passing through the center of the central mirror 15b.
α is the maximum angle of tilt of a micromirror relative to the plane containing the axes of rotation of the micromirrors.

### And,

y corresponds to the distance between the middle of the central micromirror 15b and the orthogonal projection of the middle of the output of the source 12 onto a plane parallel to the transmission surface 11
x corresponds to the distance between the middle of the output surface of the source (12) and a plane containing the axes of rotation of the micromirrors.
The central micromirror 15b is the micromirror of the matrix of micromirrors 14 which is situated closest to the geometrical center of the matrix of micromirrors 14;
β₀ is the angle formed between a central ray from the source 12 and impacting the middle of the central micromirror 15b, and a plane parallel to the transmission surface 11.

It is thus possible to define, according to the parameters of the device to be constructed, the maximum size of the original beams from the source 12 to produce the invention, in this exemplary embodiment. As indicated previously, the size of a micromirror is negligible relative to that of the source which allows the approximation of the above calculations.

Additionally or alternatively, and as introduced previously, the source can have a radius less than 100 μm.

The example of FIG. 3 and the detail given in FIG. 5 for the formation of the source 12 or of another source illustrate the formation of such sources according to a first embodiment of the invention. In particular, in the case in point, the sources 12, 32 are distinct.

Hereinbelow, different non-exhaustive solutions are described for producing such sources. It is first of all recalled that the source 12, 32 can be primary, that is to say that the light generator (an emitter) directly produces the beam of suitable size.

In another case, it is a transformation system which produces this beam on the basis of a light emitter which is not directly suited. The source employed to impact the matrix DMD is then secondary.

In FIG. 6, a light emitter 17, for example with at least one LED, directs a primary beam toward a convergent lens 19 whose image focal point is situated on or in proximity to the center of an aperture 18, preferably circular, serving as diaphragm. The size of the hole of the aperture 18 conditions the dimension of the beam from the source thus constructed and serves as secondary source to illuminate the matrix of micromirrors 14.

FIG. 7 presents a variant of FIG. 6 in which the lens 19 has been replaced by a reflector 20, preferably ellipsoid, making it possible to make the rays from the emitter converge toward the aperture 18.

Similarly, FIG. 8 shows the cooperation of an emitter 17 with a dioptric collimator 21. The emitter 17, such as an LED, is received in a light collection cavity. A convex output part makes these rays converge toward the aperture. Other aperture systems governing the size of a light spot are possible.

The case of FIG. 9 employs an optical fiber 23. Preferably, the latter receives rays of a beam converging toward its input from a convergent optic, for example a biconvex lens 22, itself receiving light from an emitter 17.

Another possibility consists in employing a laser source, of small size by construction, and possibly associating with it a conversion means to degrade its coherence. This conversion means can comprise luminophor, and notably phosphorescent, particles, or quantum dots (Q Dot).

FIG. 4 presents an alternative solution for the production of the sources 12, 32. In effect, in this figure, a primary source 33 is employed to be at the origin of all the rays supplied downstream by the sources 12, 32. The primary source 33 can correspond to one of the sources provided in the preceding examples. According to the example, it can be a laser source, an LED source possibly provided with a device for reducing the size of the beam, for example as described with reference to FIGS. 6 to 9.

In the configuration illustrated, the light from the primary source 33 is transmitted a splitter 34 by a light path which is, in the example, an optical fiber 35. Any other arrangement making it possible to guide the light rays toward the splitter 34 can give satisfaction in the context of the invention. The splitter 34 is configured to split the light from the primary source 33 into one or more output beams. Each output beam is configured to be projected onto the matrix 14 so as to produce one of the sources 12, 32. Thus, in FIG. 4, the source 32 is produced by an optical fiber 37 at the output of the splitter 34 and whose distal end corresponds to the zone of emission of the beam from the source 32. Similarly, the source 12 is produced by a fiber 36 a proximal end of which receives light rays from the splitter 34 and of which a distal end is arranged so as to provide a projection toward the matrix 14. Any other arrangement to ensure the routing of the light rays from the splitter 34 to the sources 12, 32 falls within the scope of the present invention. As indicated previously, the projection onto the matrix 14 is preferably direct for the sources 12, 32 but that is not an exclusive feature of the invention for which intermediate devices such as reflectors or lenses can be arranged.

To sum up, in the embodiment of FIG. 4, a part of the means used for the sources 12, 32 are shared. This is particularly the case with the primary source 33, the optical fiber 35 and the splitter 34. The other components such as the optical fibers 36, 37 and the conversion devices 38, 39 can be dedicated to one of the sources 12, 32.

The term source is therefore understood here to cover both a primary source and a secondary source. The beam from a source is understood to be the beam produced at the output of the assembly forming the source, whether primary or secondary.

Advantageously, the splitter 34 makes it possible to modulate the quantity of light supplied to one or other of the sources, for example in a ratio ranging from zero to 100%. As an example, the splitter 34 can be produced with one of the solutions respectively presented in FIG. 10 and in FIGS. 11 and 12.

In which FIG. 10, the fiber 35 illuminates an optical device, for example a lens 40, so as to address light rays, preferably collimated, toward the surface of a beveled mirror comprising a top mirror 43 reflecting the light toward the optical fiber 37 and a bottom mirror 44 reflecting the light toward the optical fiber 36. For example, the mirrors 43, 44 can be planar and inclined at 90°, the top of the bevel of the mirrors 43, 44 extends oriented along the optical axis of the lens 40 or of any other optical device. Preferably, the rays reflected by one and/or the other of the mirrors 43, 44 are concentrated by an optical device such as a convergent lens 41, 42. Furthermore, to allow a distribution of the light flux from the optical fiber 35, at least one out of the optical devices concerned allows a modification of the flux entering into the corresponding fiber 36, 37. In the example, the device 42, in the form of a lens, exhibits an electrically variable focal length so as to modify in particular the quantity of light admitted into the optical fiber 36. It will notably be possible to use lenses with electrically variable focal length known under the registered trademark Varioptic®. Thus, an electrical command applied to the lens 42 makes it possible to modify the light flux entering into the fiber 36.

In the variant embodiment presented in FIG. 12, the quantity of light admitted into the optical fiber 36 and controlled via a relative movement between the latter and the mirror 44 which faces it. A very small moment, notably from a few tens to a few hundreds of micros can suffice to place the mouth of the fiber 36 according to the mean direction of the rays from the mirror 44 possibly transmitted by the device 42, or to displace the fiber 36 such that less light or no more light enters therein.

The invention is not limited to the examples cited above. Furthermore, one and/or the other of the fibers 36, 37 can make use of this light splitting means. Different light splitting means can moreover be combined. The examples given above and the illustrations of FIGS. 10 to 12 should moreover not be considered as limiting on a type of mirror or a type of optic along the path of the light rays.

Whatever the embodiment, it may be useful for at least one of the sources 12, 32 to be equipped with a conversion device configured to receive an input light within a given wavelength interval and to emit in another wavelength interval. This is particularly what is illustrated in FIG. 4 with, at the output of the optical fibers 36, 37, conversion devices, respectively 39, 38, making it possible to transform the color of the light received from the primary source 33 so as to adapt it to the function or functions produced by the sources 12, 32. Thus, for example, the primary source 33 can emit in the white color wavelengths and the conversion devices 38, 39 make it possible to obtain other colors as output, notably the colors red and orange.

To this end, the conversion device 38 or 39 can be a composite plate having a light-transmissive matrix, preferably transparent, and charges in the form of luminophor particles or quantum dots called “Q dots”. The matrix is typically a polymer material such as the abovementioned PMMA or polycarbonates. This device also advantageously comprises a reflector placed at the output of the conversion device. This reflector ensures a filtering of the rays outgoing from the conversion device so as to prohibit the transmission of rays that have not been subjected to a conversion. The reflector can be a dichroic filter.

According to an alternative aspect of the invention, the source 12 and/or the additional source 32 is controlled to emit light in different colors wavelengths.

According to a first alternative, the light source is an RGB electroluminescent diode, for the acronym Red, Green, Blue and includes three light emitting surfaces which emit light respectively in the red, green and blue color wavelength. The color emitted by the light source is obtained by mixing the colors emitted by the three emitting surfaces.

According to an other alternative, the light source is an electroluminescent diode with at least two emitting surfaces emitting light in different colors wavelength choose between red, orange and white. The color emitted by the light source is obtained by selectively activating the emitting surface corresponding to the wanted color.

As indicated previously, it is advantageous for the device to have a hybrid mode of operation in which the sources 12, 32 are active simultaneously. The invention can have several hybrid modes of operation differing by the number of mirrors 15 assigned to the reflection of the rays from one or other of these sources 12, 32 to the transmission surface 11. Furthermore, the device can include other modes of operation in which one or other of the sources 12, 32 is inactive, that is to say that no light ray is obtained from one of these sources.

According to another possibility, the primary source 33 illustrated in FIG. 4 can be used for the emission of a beam, which may be permanent, directly toward the projection surface 11, without involving the reflection on the matrix 14. This embodiment is particularly advantageous when a style effect on the output outer lens of the light is desired, a style effect which may be continuous even though the lighting and signaling functions from the sources 12 and 32 are controlled according to the desired mode of operation and according to the lighting or signaling functions to be provided. For example, on the basis of the optical fiber path 35, 36, 37 of FIG. 4, one or more branch optical fibers may be connected to one of these fibers and configured to directly direct the light to the transmission surface 11. This branch fiber or these branch fibers may be connected to the fiber 35. The expression directly means without passing through the matrix 14, the projection to the transmission surface 11 being able to be provided with intermediate elements and in particular waveguides or even optical reflection devices or diopters. The additional fibers can notably be diffusing fibers observed through the output surface of the light.

The invention is not limited to the embodiments described but extends to any embodiment conforming to the spirit thereof.

### REFERENCES

1. projection zone
2. source
3. reflector
4. matrix
5. lens
6. optical system
10. device
11. transmission surface
12. source
13. point
14. matrix
15a,15b,15c. micromirror
16. reference plane
17. emitter
18. aperture
19. lens
20. reflector
21. dioptric collimator
22. lens
23. optical fiber
32. additional light source
33. primary source
34. splitter
35. optical fiber
36. optical fiber
37. optical fiber
38. conversion device
39. conversion device

1. A rear lighting and/or signaling device, notably for a motor vehicle, comprising a light source, a transmission surface and means for distributing at least a part of the light from the source on the transmission surface, the distribution means comprising
a matrix of micromirrors that can each be driven according to at least two different inclination positions comprising a first position in which rays from the source are returned by a micromirror to the transmission surface and a second position in which the rays from the source are not returned by a micromirror to the transmission surface, wherein it comprises at least one additional light source configured such that rays from the additional source are returned by a micromirror to the transmission surface when said micromirror is in the second position and are not returned by a micromirror to the transmission surface when said micromirror is in the first position, the distribution means comprising at least one hybrid mode of operation in which the source and the additional source are simultaneously emissive and in which at least a part of the micromirrors are in the first position and at least another part of the micromirrors are in the second position.

2. The device according to claim 1, wherein the source and the additional source have different light emission wavelength intervals.

3. The device according to claim 1, wherein the source is configured to emit light in the red color wavelengths.

4. The device according to claim 1, wherein the additional source is configured to emit light in the orange color wavelengths.

5. The device according to claim 1, wherein the radiated power of at least one out of the source and the additional source is less than 1 W.

6. The device according to claim 5, wherein the source and the additional source share a same primary source, the device comprising a splitter of light rays from the primary source between the source and the additional source.

7. The device according to claim 6, comprising an optical fiber conducting light from the primary source to the splitter.

8. The device according to claim 6, wherein at least one out of the source and the additional source comprises an optical fiber conducting light output from the splitter and a distal end of which is directed toward the matrix.

9. The device according to claim 6, wherein at least one out of the source and the additional source comprises a conversion device configured to receive light from the primary source and to re-emit light converted to a wavelength interval different from that of the light from the primary source.

10. The device according to claim 9, wherein the conversion device comprises luminophor elements.

11. The device according to claim 6, comprising a light diffuser configured to receive light rays from the primary source and to return them at least partly to the transmission surface, without reflection on the matrix.

12. The device according to claim 1, wherein the distribution means comprise at least one other mode of operation in which the source is emissive and the additional source is non-emissive and in which at least a part of the micromirrors are in the first position and at least another part of the micromirrors are in the second position.

13. The device according to claim 1, wherein the distribution means comprise at least one other mode of operation in which the source is non-emissive and the additional source is emissive and in which at least a part of the micromirrors are in the first position and at least another part of the micromirrors are in the second position.

14. The device according to claim 1, wherein the distribution means comprise at least one other hybrid mode of operation in which the source and the additional source are simultaneously emissive and in which at least a part of the micromirrors are in the first position and at least another part of the micromirrors are in the second position, the number of micromirrors in the first position and/or in the second position being different therein from the number of micromirrors in the first position and/or in the second position of the hybrid mode of operation.

15. The device according claim 1, wherein at least one out of the source and the additional source is configured to emit a light beam whose source output radius is less than 100 μm.

16. The device according to claim 15, wherein the light beam is divergent and directly illuminates the matrix of micromirrors.

17. The device according to claim 1, wherein at least one out of the source and the additional source comprises at least one out of: a light-emitting diode, a laser emitter, a semiconductor light source comprising a plurality of light-emitting units of submillimetric dimensions.

18. A lighting and/or signaling light of a motor vehicle equipped with at least one lighting and/or signaling device according to claim 1.

19. The rear light according to claim 18, comprising an outer lens for outputting light from the light, said outer lens comprising the transmission surface.

20. The device according to claim 2, wherein the source is configured to emit light in the red color wavelengths.
